(19) United States
(12) Patent Application Publication
(10) Pub. No.: US 2004/0042941 A1
(43) Pub. Date: Mar. 4, 2004

(54) Miniature apparatus for delivering electromagnetic energy into a solution

(76) Inventors: Austin Darragh, County Meath (IE); David Darragh, County Dublin (IE)

Correspondence Address: HOFFMANN & BARON, LLP, 6900 JERICHO TURNPIKE, SYOSSET, NY, 11791, US

(21) Appl. No.: 10/433,197

(22) PCT Filed: Nov. 29, 2001
(86) PCT No.: PCT/IE01/00149

(30) Foreign Application Priority Data
Nov. 29, 2000 (IE) S2000/0971

(51) Int. Cl. C02F 1/48; B01J 19/08

(52) U.S. Cl. 422/186.29; 210/748; 422/186.04

(57) ABSTRACT

Apparatus for delivering electromagnetic energy into a solution comprises a power source (11), an oscillator crystal (12) and an antenna (14) for transmitting the generated signal into the solution. The solution is water which is used to irrigate plants and flowers for which can be used for consumption by humans or animals or for use in domestic applications.

The present invention relates to an apparatus for delivering electromagnetic energy into a solution and in particular to a miniature version which can easily be transported and can be used for many applications where it is desired to deliver electromagnetic energy into a solution to modify its characteristics such as Zeta potential.

WO-A-9622831 discloses a apparatus for delivering electromagnetic energy into a solution Preferred embodiments of delivery apparatus disclosed in this prior art document comprise a tubular housing having closed ends and forming a water tight chamber, a coil contained within the chamber delivering a magnetic field into a solution, at least one electric field probe coupled to the coil for delivering an electric field into the solution and coupling means for coupling an electromagnetic signal to the coil.

This apparatus is very useful for treating large volumes of a solution, usually water, however the apparatus is only suitable for a large installation and is not suitable for use in many situations and is not readily transportable.

The present invention provides an apparatus for delivering electromagnetic energy into a solution comprising a power source, an oscillator crystal means for generating an electromagnetic signal such as a radio frequency (RF) signal, and an antenna for transmit the generated signal into a solution.

The power source may be a battery, a DC mains adaptor, a rechargeable battery or a rechargeable battery with a backup battery, or a rechargeable battery with a DC generator powered by water flow.

Conveniently, the apparatus includes an indicator for indicating that the battery is charging when a rechargeable battery is used as a power source.

Conveniently, the apparatus includes a zener diode to regulate the voltage applied across the oscillator crystal means.

Conveniently, the apparatus includes a buffer chip to regulate the output of the oscillator crystal means to the antenna.

Preferably, the apparatus includes a switch and a separate means for indicating when the apparatus is operating and optionally includes one or more diodes to allow current to flow in one direction and to protect a rechargeable battery from being improperly charged. The antenna may be an elongate wire the length of which approximates to a fractional length of the RF signal generated by the oscillator crystal means, can include a bras ball, at its end and an optional covering element and may be locatable along the inside of a pipe used to supply water.

Conveniently, the apparatus includes a filter to reduce or eliminate secondary or tertiary harmonics from the output of the generated signal.

The invention will hereinafter be more particularly described with reference to the accompanying drawings which show, by way of example only, a number of embodiments in accordance with the invention.

In the drawings:

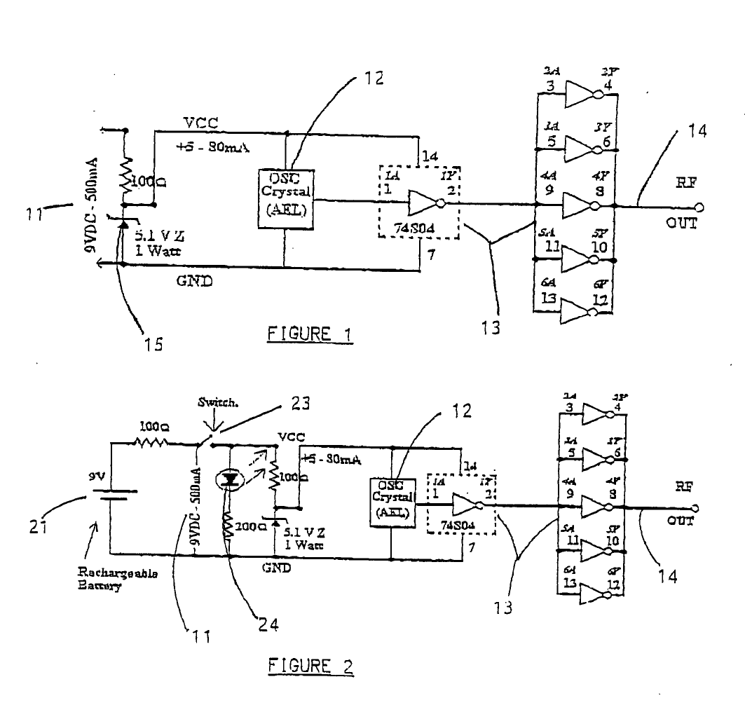

FIG. 1 is a circuit diagram of a first embodiment of an apparatus for delivering electromagnetic energy into a solution;

FIG. 2 is a circuit diagram of a second embodiment of an apparatus according to the invention; the second embodiment having a power on light, a back-up battery and power on switch;

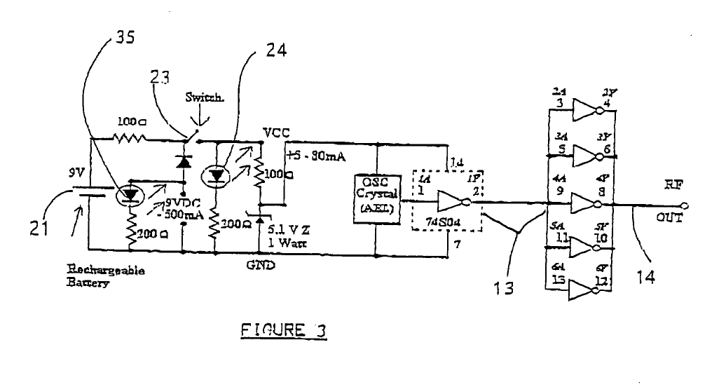

FIG. 3 is a circuit diagram of a third embodiment of apparatus according to the invention, which includes an indicator to indicate that a mains adapter powers the unit;

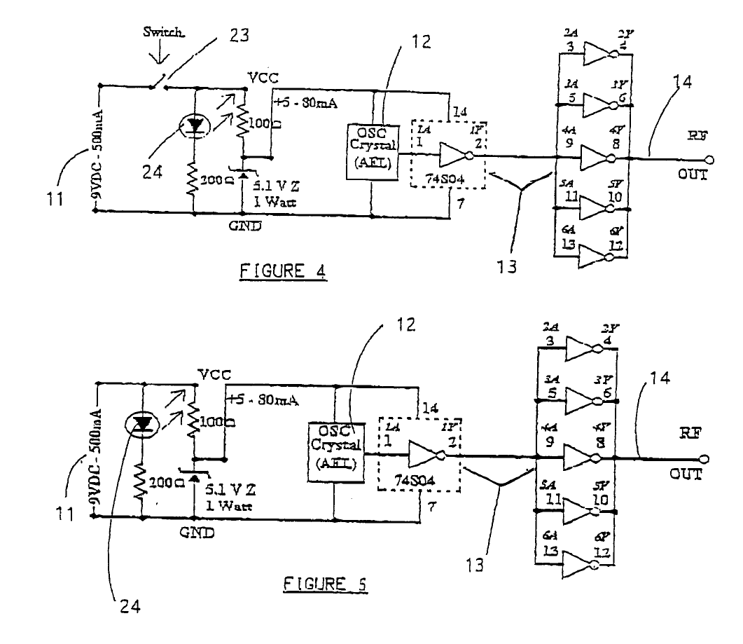

FIG. 4 is a circuit diagram of a fourth embodiment of apparatus according to the invention, similar to the first embodiment but having a power on indicator and a switch;

FIG. 5 is a circuit diagram of a fifth embodiment of apparatus according to the invention similar to the first embodiment with a power on indicator;

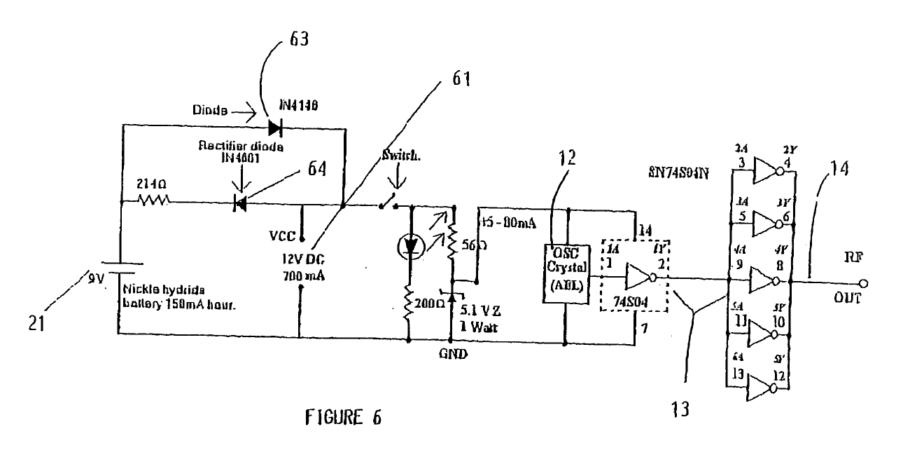

FIG. 6 is a circuit diagram of a sixth embodiment of apparatus according to six invention;

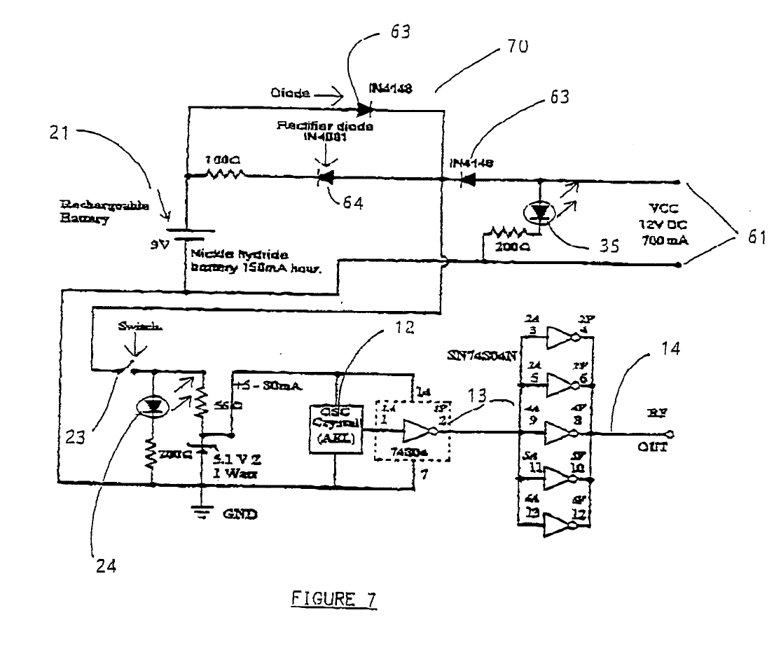

FIG. 7 is a circuit diagram of a seventh embodiment of apparatus according to the invention which combines the features of the first six embodiments.

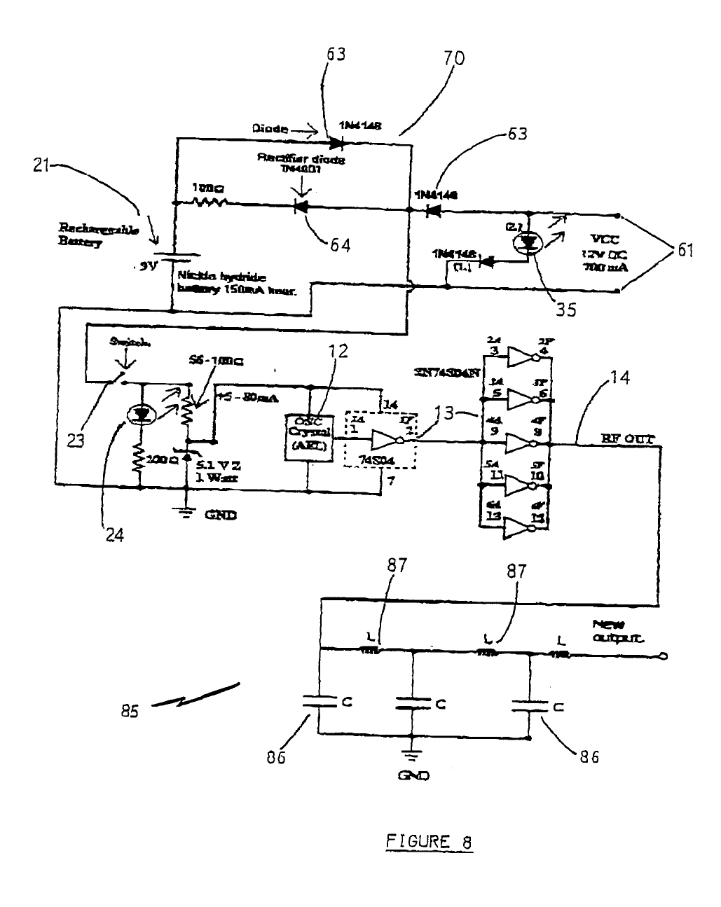

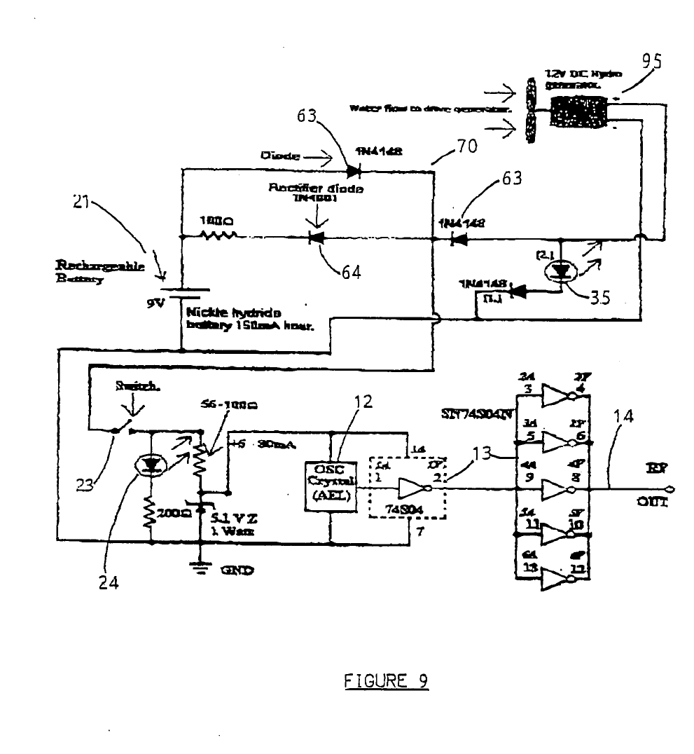

FIG. 8 is a circuit diagram of an eighth embodiment of apparatus according to the invention which is a modification of the seventh embodiment; and

FIG. 9 is a circuit diagram of a ninth embodiment of apparatus according to the invention which is a further modification of the seventh embodiment.

Referring to the drawings and initially to FIG. 1, the first embodiment 10 of apparatus for delivering electromagnet energy into a solution comprises a 9V mains adapter 11, an oscillator crystal 12, a buffer chip 13 and an antenna 14. A Zener diode 15 allows only 5.1 volts to pass through as the oscillator crystal 12 only requires a supply voltage of 5 volts±0.1 volts. The oscillator crystal is the main component of the apparatus and in this particular embodiment outputs a radio frequency signal of 20 MHz which is sent through the buffer chip 13 to the antenna 14. Similar components in the other embodiments are given similar numbers as in the first embodiment.

The second embodiment 20 is similar to the first embodiment, except that it includes a rechargeable battery 21 as well as the 9V mains adapter 11. Battery 21 acts as a backup power source. It also includes a switch 23 and a light emitting diode (LED) 24 which emits light when the switch 23 is closed and the unit is operating.

The third embodiment 30 is similar to the second embodiment 20 but includes a separate LED 35 which is used to indicate that the unit is being powered by a mains adapter. The LED 35 emits a red light to distinguish it from the LED 24 which emits a green light.

The fourth embodiment 40 includes a 9V mains adapter power supply 11, an LED 24 for indicating power on and a switch 23 for operating the unit.

The fifth embodiment 50 is similar to the first embodiment 10 and includes a power on light LED 24.

The sixth embodiment 60 is similar to the second embodiment 20 but includes a mains adapter 61 which gives a 12V DC supply of 700 mA. It has a power supply socket (not shown) which accepts a jack plug from the adapter. The circuit also includes two diodes 63 and 64 which only allow current to flow in the direction which it is pointed. Diode 63 enables the battery 21 to drive the main circuit when the mains adapter 61 is not charging or plugged into the apparatus. Diode 63 also protects the battery from being improperly charged when adapter 61 is plugged in and opening the circuit.

The seventh embodiment 70 shown in FIG. 7 includes the majority of the components used in the first six embodiments, namely a rechargeable battery 21, a crystal oscillator 12, a buffer chip 13, an antenna 14, a switch 23, an LED 24, an LED 35, a mains adapter 61, 3 diodes 63, 63(a) and a diode 64. Diode 63(a) only allows LED 35 to illuminate when the mains adapter 61 is plugged into the apparatus.

The eighth embodiment 80 shown in FIG. 8 is similar to the seventh embodiment 70 except that it has an output modified by filter circuit 85 to reduce secondary and tertiary harmonics so as to reduce interference with other wavelengths and keep the output frequency to a constant value which in the eighth embodiment in the range 27.225 MHz to 27.255 MHz. The filter circuit 85 includes three capacitors 86 and three impedances 87.

The ninth embodiment 90 shown in FIG. 9 is also similar to the seventh embodiment 70 except that it has a generator 95 for generating a DC supply from the flow of water which is used to recharge battery 21.

In relation to all of the above embodiments, the antenna 14 is an elongate wire which in the particular embodiments used us 0.889 m in length which approximates to 1/16 of the particular wavelength of the RF signal generated by the crystal oscillator 12. In a modification (not shown) the antenna has a brass ball on the end of it with a cover.

The apparatus according to the invention has numerous applications; it can be used to treat water used to irrigate plants and flowers. The antenna can extend along the inside of a hosepipe used to supply water to the plants. It can be demonstrated that it enhances plant growth by achieving higher yields of fruit, vegetables, plants, flowers, shrubs, trees and other plant life. The apparatus can also be used to treat water used in domestic applications, it helps prevent or eliminate scaling in kettles, coffee making machines, taps, faucets and showerheads.

It will of course be understand that the invention is not limited to the specific details described herein, which are given by way of example only and that various modifications and alterations may be made without departing from the scope of the invention as defined in the appended claims.

1. An apparatus for delivering electromagnetic energy into a solution comprising:
a power source;
an oscillator crystal means for generating an electromagnetic signal such as a radio frequency (RF) signal; and
an antenna for transmitting the generated signal into the solution.

2. An apparatus for delivering electromagnetic energy into a solution as claimed in claim 1, in which the power source is selected from one of the following:—
a battery;
a DC mains adapter;
a rechargeable battery;
a rechargeable battery with a backup battery; or
a rechargeable battery with a DC generator powered by water flow.

3. An apparatus for delivering electromagnetic energy into a solution as claimed in claim 2, which includes means for indicating that a battery is charging when a rechargeable battery is used as a power source.

4. An apparatus for delivering electromagnetic energy into a solution as claimed in any one of the preceding claims, including a zener diode to regulate the voltage applied across the oscillator crystal means.

5. An apparatus for delivering electromagnetic energy into a solution as claimed in any one of the preceding claims, including a buffer chip to regulate the output of the oscillator crystal means to the antenna.

6. An apparatus for delivering electromagnetic energy into a solution as claimed in any one of the preceding claims, including a switch and a separate means for indicating when the apparatus is operating.

7. An apparatus for delivering electromagnetic energy into a solution as claimed in any one of the preceding claims, including one or more diodes to allow current to flow in one direction and to protect a rechargeable battery from being improperly charged.

8. An apparatus for delivering electromagnetic energy into a solution as claimed in any one of the preceding claims in which the antenna is an elongate wire, the length of which approximates to a fractional length of the RF signal generated by the oscillator crystal means.

9. An apparatus for delivering electromagnetic energy into a solution as claimed in claim 8, in which the antenna is provided with a brass ball at its end and an optional covering element.

10. Au apparatus for delivering electromagnetic energy into a solution as claimed in any one of the preceding claims including a filter to reduce or eliminate secondary or tertiary harmonics from the output of the generated signal.

11. An apparatus for delivering electromagnetic energy into a solution as claimed in any one of the preceding claims, in which the antenna is locatable along the inside of a pipe used to supply water.

12. An apparatus for delivering electromagnetic energy into a solution as claimed in claim 11, in which the water pipe delivers water for irrigating plant life such as grass, fruit, vegetables, blooms, shrubs and trees.

13. An apparatus for delivering electromagnetic energy into a solution as claimed in claim 10, in which the water pipe delivers water for use in domestic applications, whereby the apparatus helps prevent or eliminate sealing in kettles, coffee in making machines, taps, faucets, shower heads and the like.

14. An apparatus for delivering electromagnetic energy into a solution substantially in accordance with any of the embodiments as herein described with reference to and as shown in the accompanying drawings.

15. A method for treating water by delivering electromagnetic energy into the water using apparatus as claimed in any one of the preceding claims.
